(19) United States
(12) Patent Application Publication
(10) Pub. No.: US 2005/0181803 A1
(43) Pub. Date: Aug. 18, 2005

(54) System for combining geographic location information, database-derived affinity matches, and user control in order to permit individuals to rendezvous

(76) Inventors: Christopher S. Weaver, Darnestown, MD (US); Charles L. Jackson, Bethesda, MD (US)

Correspondence Address: DEWITT ROGGIN PLLC, 12 E. LAKE DRIVE, ANNAPOLIS, MD, 21403, US

(21) Appl. No.: 10/780,093

(22) Filed: Feb. 17, 2004

(51) Int. Cl. H04Q 7/20

(52) U.S. Cl. 455/456.1

(57) ABSTRACT

A system combining features of affinity and/or preference matching, location services, wireless devices, and security to provide users with controllable ability to rendezvous or track based upon user-defined interests or characteristics. Security features may include multiple levels of user-selected security and identification of users by a variety of means, including biometrics and image recognition.

### CROSS-REFERENCE TO RELATED APPLICATIONS

None.

### STATEMENT REGARDING FEDERALLY SPONSORED RESEARCH OR DEVELOPMENT

Not applicable.

### FIELD OF THE INVENTION

The present invention relates to the field of affinity and preference matching, and more specifically, relates to providing affinity matching combined with location services, wireless communications devices, and security features.

### BACKGROUND OF THE INVENTION

Perhaps the most familiar example of an affinity matching system is a computerized dating service. Such a service gathers data, such as age, hair color, languages spoken, education, hobbies, from a large number of individuals. The service then provides a variety of matching services-pairing individuals whose data indicate that they may be good matches.

A variety of tools have been used to permit people with compatible or complementary interests to meet with one another for social, economic, political, or religious purposes. Such tools include markets-locations where buyers and sellers congregate, advertisements, customary meeting places (chess players congregate in some parks but not others), brokers in various industries, and computer dating services. Computer matching services gather data regarding their clients and their client's interests. They then use computer tools to match individuals. One such method of matching is to compare one client's data (such as age, location) with the preferences of another client and to generate a score. If the score is sufficiently high, then the two clients are declared to be matches. Alternatively, the system may require high scores for the match in both directions. Participating individuals are provided with information regarding those individuals with whom they have been matched. These types of matching are sometimes referred to as “affinity matching.”

Portable cellular and PCS telephones are battery powered two-way radio-based voice communications systems. Today's portable wireless phones weigh a few ounces can easily be carried by a person-put in a pocket, clipped to his or her belt, or placed in a purse.

Although less familiar to most people, there are also a number of wireless data terminals, such as two-way pagers, Blackberry devices, and PDA's. These devices permit communication with text, rather than voice. They have the advantage that they can be used in locations where speech would not be possible (libraries, noisy locations) and they can intercommunicate with email and other text messaging systems.

For purposes of this specification, the term “portable wireless terminals” will be used generally to refer to any of these types of devices.

Several technologies permit the determination of the location of a device with reasonable accuracy. These types of technologies will be referred to generally as “location services.” One such system is the GPS satellite system. In the GPS system, signals from multiple satellites are processed by the receiving system. By comparing the signals from several satellites a receiving system can determine its location to within several meters. The GPS system is now complemented by the wide area augmentation system (WAAS). This system broadcasts additional information that permits GPS receivers to refine their location estimates. Using WAAS, systems can routinely locate objects to within a few meters. For more information on GPS and WAAS see Global Positioning System: Theory and Application, edited by B. Parkinson, J. Spilker, and http://gps.faa.gov/Programs/WAAS/waas.htm and

The Federal Communications Commission (FCC) requires commercial mobile radio service providers (CMRS) to provide location information when a wireless subscriber calls 911. Hence, wireless systems have the capability of determining the location of a subscriber to within about 50 to 100 meters.

Combining location information, such as might be derived from a wireless carrier's ability to locate subscribers for E911 purposes, with data base information indicating mutual interests or affinity could provide a variety of useful information to consumers.

A prototypical example is a matching service for singles. A user at a large bar could post an inquiry into the database to see if anyone with a matching profile were present at the same location. But, of course, one can think of many other related applications. For example, the same capabilities might be used to enable classmates to find one another at college football games.

U.S. Patent Application 20020184653 describes affinity matching as an application for a location service. It states,
In a final example, the device 102 is used to alert the user when certain other individuals are close by. For example, the user might indicate in his profile that he is interested in meeting other individuals with an interest in Civil War memorabilia. The user's profile is stored at the service provider system 120. As the user strolls around town, the service provider system 120 tracks the location of the device, as well as the locations of devices of other users. If any of the other users are nearby and also indicate an interest in Civil War memorabilia, the service provider system 120 alerts the users so that they may meet each other if they so desire. Different criteria, including for dating and matchmaking, may be used.
   Although that “final example” a describes a general idea of combining affinity matching with location services, it is too generalized to represent a viable system.

The present invention provides an enhanced combination affinity matching/location service having, among other things described below, efficient implementation, user security, user convenience, and the trading off of geographic separation against the degree of match.

### SUMMARY OF THE INVENTION

The present invention combines electronic communications, electronic position location services, computer databases, and portable voice and data terminals in order to provide improved affinity matching services.

The present invention encompasses a system for matching users by affinity and geographic location. The system includes, among other things, a communications system for providing service to portable terminals; a computing facility connected by a telecommunications link to the portable communications terminals of the communications system; a location service capable of providing location information to the central computing facility; data storage for storing information regarding affinity preferences of a user; one or more computers or processors for determining a match based upon a degree of affinity correlation between two users where a degree of affinity correlation constituting a match varies depending on the proximity of the two users, and means for sending an alert message to a user when a match is determined.

Aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the architecture and method, given only by way of example, and with reference to the accompanying drawings, in which:

FIG. 1 is an overall diagram of the system, showing the major subsystems and their interconnection.

FIG. 2 is a flow chart depicting a process of initialization of quadratic combining for a single user in accordance with an embodiment of the invention.

FIG. 3 is a flow chart of an operation of a single instance of quadratic combining in accordance with an embodiment of the present invention.

### DESCRIPTION OF THE PREFERRED EMBODIMENTS

The present invention combines technologies from a variety of separate fields, including at least affinity matching, wireless communications terminals, and location services.

For purposes of this specification, the following terminology will be used:
Users: the individuals whose location is tracked, whose affinity information is stored in one or more databases, and who provide control inputs to the system.
Database: a combination of computer hardware and software that permits storing large amounts of information and answering queries regarding the stored information.
Location Service: a system that can provide reasonable estimates of the geographic location of a person or object and can transmit that location information to a computing facility. For example, a global positioning system (GPS) receiver combined with a cellular telephone could provide a location service.

The general usefulness of combinations of affinity matching and location services can be seen from the following examples:

### Example 1

### Finding Classmates at a College Football Game

A significant portion of the audience at a college football game are alumni of the two colleges whose teams are playing. People often enjoy meeting with their classmates at such events. Individuals using the service would carry a cell phone equipped with a location service. The database would contain their college and the date of graduation. The location of each user would be transmitted to the database. Matching software would detect whenever two participating classmates were within, say 25 meters of one another, and would send each participant a brief message with the name and picture of the nearby classmate.

### Example 2

### Find Someone Interested in Antique Telephones at an Antique Show

Antique shows are a mechanism for the efficient congregation of multiple buyers and sellers of antiques to meet in a specific location. Some persons at such shows may have specialized interests-such as collecting antique telephones—that they would like to share and discuss with others having similar interests. Individuals using the service would carry a cell phone equipped with location service and would enter into the database their specific interests. Matching software would detect whenever two individuals with joint interests were close to one another and would place a telephone call connecting the two individuals.

### Example 3

### Couples Matching Service

With regard to computer dating services, Users generally provide various personal data (such as date of birth, name, picture, hobbies, interests, profession, etc.) that is stored in a database and cross-matched according to programmed criteria defined by that service. Individuals using the Affinity Location Matching Service (ALMS) would carry a cell phone or wireless Phone/PDA device or other interactive computer device equipped with location service capability. The cross-matching software would detect whenever two users whose profiles indicated a likely match or compatibility were geographically close to one another, or where the position location information determined with some statistical probability the extrapolated position of the parties within a certain amount of time—say two converging parties on the same street or parties moving toward the same commercial establishment within a certain amount of time. The software would then generate messages to each of those parties advising them of the proximity of a possible affinity match. Such messages would logically follow a certain pattern for purposes of enhancing personal security. The initial message would indicate that a likely match was nearby, and ask the user if he or she wished to proceed further with the match. In the event the user said no, the service would end the call. If the User indicated a possible interest but wanted to see a profile on the other person, the service would download certain portions of the match profile data while purposely removing certain identification data such as physical description or photographs. If the parties desired to continue with the match, the computer would either download a photograph or physical description information and offer to connect the users via cell while blocking (or overlaying) telephone identification information so that they could then speak with each other but with each user maintaining anonymity. The system could also simultaneously direct the cellular telephone/PDA/portable computer to establish a graphic location/relative orientation map to each of the users. The users would then decide whether or not to meet. At each step in the process, each party has control over the amount of information to be provided to the other party as well as the option of screening or terminating the match attempt. This methodology provides for maximum privacy and security. At any point in the query process if either user desires that the process be stopped or truncated, the connection would be terminated, a prerecorded or computer generated audio announcement accompanied by companion text would indicate that the match process had been terminated at the request of one of the parties and an update notation made in the central database indicating that no further matches between these individuals were to trigger affinity messages.

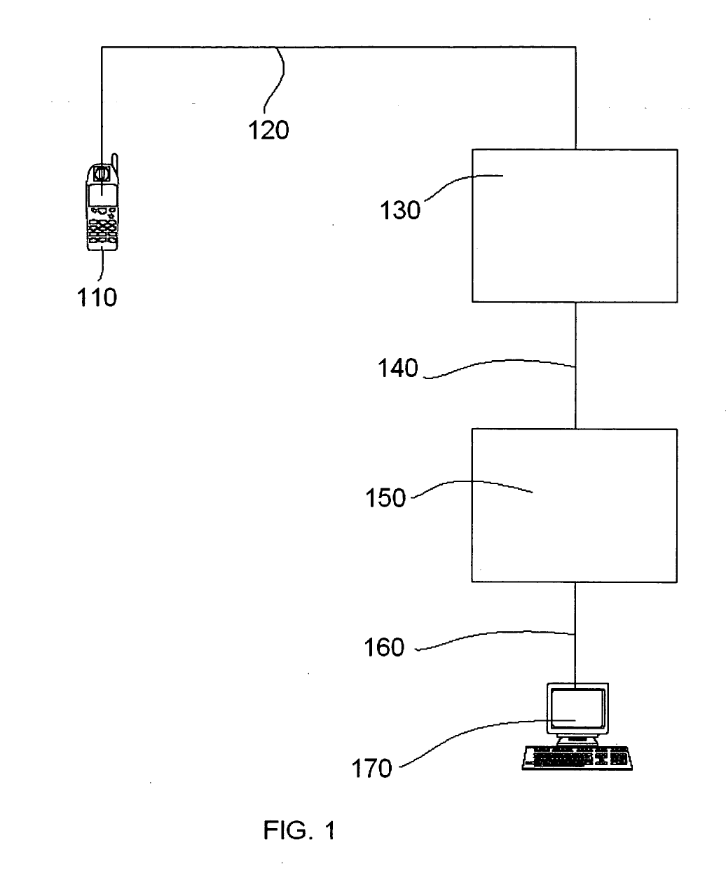

As shown in FIG. 1, the a basic structure for a preferred embodiment comprises a user's location-enabled device 110, a wireless connection 120, a location service provider 130, a telecommunications means 140, a computer facility 150, a communications connection 160, and a data entry terminal 170. The user's location-enabled device communicates with the location service provider 130 via the wireless connection 120. The location service provider 130 communicates with the computer facility 150 via a telecommunications system 140. The computer facility 150 communicates with the data entry terminal 170 via communications connection 160.

The computer facility 150 has storage media or memory for storing affinity preferences of users. The storage devices or memory could be any means for storing data, such as hard disk drives, RAM, and the like. Typically, the affinity preferences of many users would be stored at the computer facility. The computer facility could store affinity preferences of all users enrolled in the system, or it could store the affinity preferences only on a temporary basis while a user is actively using the system. A user's affinity preferences may be entered into the system in a variety of ways, such as being entered through a data entry terminal at the computer facility, through a computer connected to the internet, or through a user's portable communications terminal.

Additionally or alternatively, a user's affinity preferences could be stored locally in memory or other storage in the user's portable communications device and transmitted to the computer facility. Such transmission could occur at a variety of different times depending on the arrangement of the system. For example, the system may be arranged such that user enrolls in or enables the system by entering his or her affinity preferences at his or her portable communications terminal and transmitting them to the computer facility. The user additionally could modify his or her affinity preferences and transmit those modified preferences to the computer facility. Yet another possibility would be to provide the user with the ability to activate or deactivate their participation in the system at will through their portable communication terminal. Whenever the user activates their participation, their portable communications terminal would transmit their affinity preferences to the computer facility.

The structure of FIG. 1 represents one preferred embodiment of the invention, but other preferred embodiments of structures for the invention will be readily apparent to those of skill in the art from this disclosure. For example, the computer facility 500 may communicate with the a user's location-enabled device directly through wireless connection 200 or a combination of wireless connection 200 and telecommunications 400 rather than communicating through the location service provider 300.

In the preferred embodiment, users are natural persons or groups of natural persons, such as a family, traveling together. In this embodiment, location-enabled devices are wireless telephones, wireless data terminals such as the Blackberry, or other wireless communications devices. These classes of devices may be collectively referred to as portable communications terminals.

The location service is a commercial service or special hardware that, from time to time informs the central computing facility of the location of all users or that otherwise permits the central computing facility to determine the location of all users. The Federal Communications Commission requires cellular and PCS service providers to support enhanced 911 including determining the geographic location of users calling 911 and providing that geographic location information (latitude and longitude) to the public safety answering point (see 47 CFR 20.18). Thus, cellular and PCS carriers must deploy equipment that will allow them to determine the location of their subscribers.

The global positioning service (GPS) is a satellite navigation system run by the United States Department of Defense (see http://gps.losangeles.af.mil/). The Federal Aviation Administration operates systems that augment the GPS signals thereby providing greater accuracy in some circumstances (see http://gps.faa.gov). The combination of a GPS receiver and a data link from a user to the central computing facility would provide a second form of location service.

Other radio-based technologies can also provide location information. Non-radio based technologies for determining location include inertial navigation systems, which calculate location information by measuring the acceleration of the system and calculating displacements from a known origin, and dead-reckoning systems, which calculate location information by measuring rate and direction of travel. Of course, systems can combine these technologies, for example a system might use GPS when the GPS signal is available but then switch over to dead reckoning whenever the GPS signal becomes unavailable.

Computer facility refers to a computational subsystem consisting of:
One or more computers with associated data storage capability,
Database software such as Oracle, Microsoft SQL server, or mySQL,
Software for performing the affinity matching calculations, Software that can retrieve the location information for users, and
Other supervisory, data entry, and control software.

The hardware comprising the computer facility need not all be located at the same site. For example, the computer facility may be implemented as systems at two separate locations in order to promote reliability.

The computer facility will be connected to the public switched telephone network (PSTN) operated by carriers such as AT&T, MCI, Sprint, Verizon, SBC, and Bell South. The computer facility will also be connected to data communications networks such as the Internet.

In its simplest form, the system operates as follows. First, the database is initialized with (1) the affinity information of users, (2) with the information needed to permit a computer, under the control of specialized software, to ascertain from the location service or services the location of each user, (3) the information needed (such as a telephone number, an Internet Protocol address, an email address, or a URL) to send a voice or data message to each user.

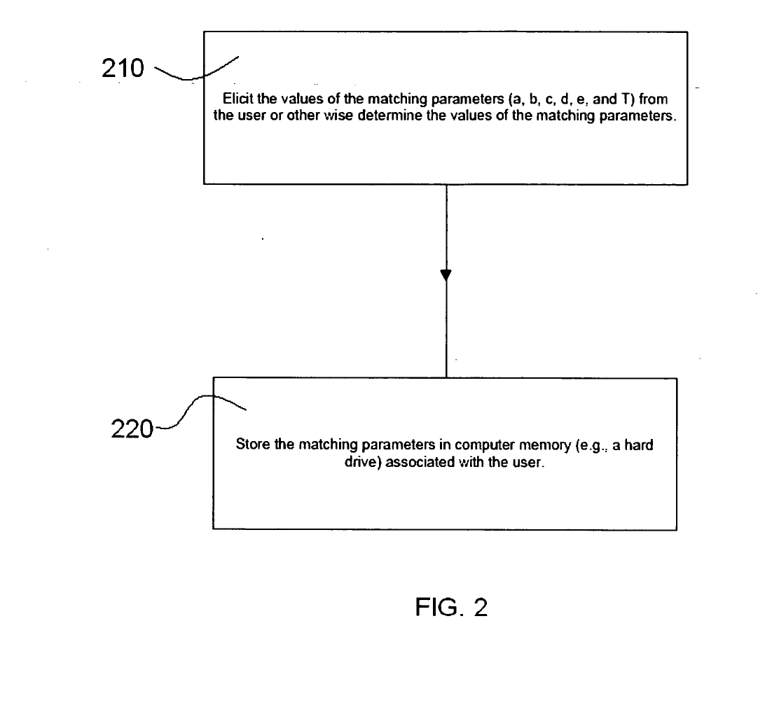

FIG. 2 shows steps involved in initializing the database with the affinity information for the user. In step 210, the values of the matching parameters (a, b, c, d, e, and T are elicited from the user or otherwise determined. As previously noted, the values of the matching parameters—or affinity preferences—of a user could be elicited or determined in a number of different ways. In step 220, the matching parameters are stored in computer memory, such as a hard drive, RAM or other storage media associated with the user.

Second, the computing facility calculates affinity scores for all pairs of users and stores in the database information that permits rapid recovery of the identity of those users whose affinity score or match with a given user is sufficiently high. One way to do this would be to associate in the database files for each user a list of other users with such high affinity scores. Below, the term affinity list is used to refer to the stored means for rapid recovery of the identity of users having an affinity match with a given user.

Third, at regular intervals the computing facility transmits a request to the relevant location system asking that the location system transmit to the computing system the location of a specific user. The computing facility transmits such requests asking for the location of each and every user at regular intervals. The computing facility then processes this pool of location information, identifying those users that are in proximity with one another. One way to perform this identification would be to calculate the distance between users and compare that distance with a stored threshold value such as 1,000 meters (or 100 meters or 10 meters). The appropriate value of the threshold would depend on the specific affinity match desired. Methods for calculating both exact and approximate distances using location coordinates such as latitude and longitude or mapping grids coordinates are well known. If the computing facility determines that two users are close to one another, that is are within the threshold distance, it then examines the affinity list of each user to determine if the other user is an affinity match. Note that affinity lists need not be symmetric. That is user A may be identified as having an affinity with user B, but not vice versa. Of course, in many applications, affinity matches are defined by a process that makes them symmetric.

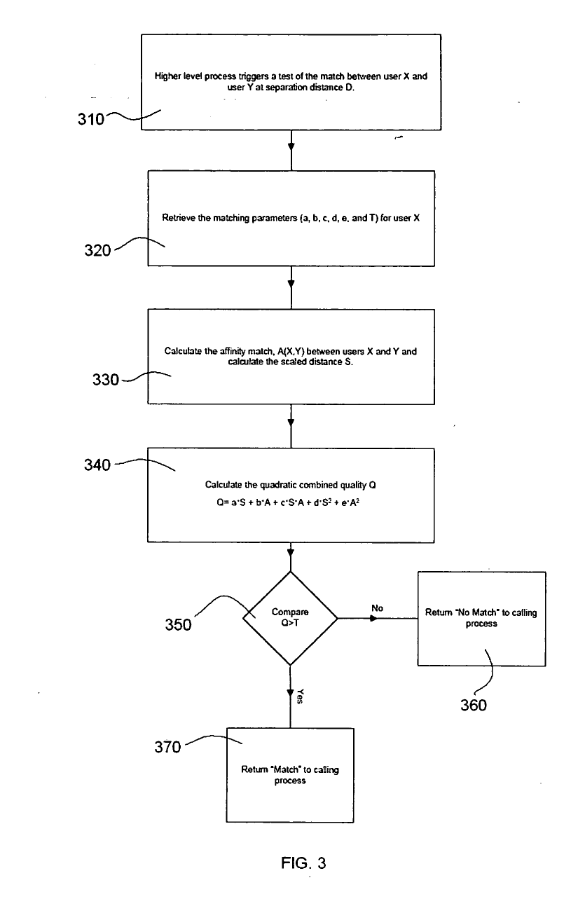

The matching performed may be a function of both affinity and distance. FIG. 3 illustrates the operation of a single instance of quadratic combining in a preferred embodiment. In step 310, a higher level process triggers a test of the match between user X and user Y at separation distance D. In step 320, the system retrieves the matching parameters (a, b, c, d, e, and T) for user X. In step 330, the system calculates the affinity match A(X,Y) between users X and Y and calculates the scaled distance S. In step 340, the system calculates the quadratic combined quality Q using the formula:
Q=a*S+b*A+c*S*A+d*s²+e*A²
At step 350, Q is compared to T. If Q is greater than T, the system proceeds to step 370 in which a “match” is returned to the calling process. If T is less than or equal to Q, the system proceeds to step 360 at which the “no match” is returned to the calling process.

On finding that, for a given user A, there exists an affinity match to a nearby user B, a message is sent to user A, notifying user A of the existence of the match and providing information permitting the easy identification of user B. Such a message may be sent as either a text or data message and may be sent as either a one-way transmission, such as email or voice mail, or as a two-way transmission such as a telephone call.

Those skilled in the art will appreciate that the information in the user database could be continuously updated rather than being prepared in advance. Indeed, operation of the system at the same time as data regarding users was added, updated, or eliminated would be the preferred method of operation.

One important modification to this basic design concerns the timing of the requests for location information that are transmitted from the computing facility to the location service.

Transmitting such requests at regular intervals could unnecessarily consume resources and thus be overly expensive or wasteful. Several methods can be used in place of the transmission of requests are regular intervals. One such approach is to take into account how much a user's location changes between successive requests. Consider a system that begins by requesting location information at intervals of two minutes. For those users whose location has only changed slightly or not at all in the most recent interval between requests, future location requests are scheduled father apart—say once every 5 minutes. In contrast, for those users whose location has changed significantly between the two most recent location requests, location request are scheduled to occur closer together in time—say once every one minute.

Similarly, users may not need to have the affinity matching capability activated at all times. They may agree to a prearranged schedule, say the affinity matching service would be active from 5 PM Friday through 10 PM Sunday each week. Location request would only be sent during the time that the subscriber had scheduled such activity. The scheduling of location requests could also vary according to (1) prices for location service charged by service providers and (2) indications by service providers that their system is congested or that that another reason exists for the affinity matching service to reduce the burden it is placing on the location service.

Alternatively, the location service may autonomously transmit position updates to the affinity matching service. This alternative offers at least two advantages. First, if the location service is a built-in capability of a terminal, such as a combined Blackberry/GPS receiver, the terminal may not be equipped to respond to requests from the computing facility but may have the capability of autonomously sending location information to the computing facility. Second, if the location service is continuously monitoring the user's location, the location service can transmit location updates for the user to the computing facility only when the user's location has changed significantly. Such transmission on demand will reduce the communications burden on the system.

An alternative design begins with the same elements as before, terminals, location service, and computer facility. However, rather than continuously monitoring the location of all users, the system is query driven. A user, user A, desiring a possible match would send an inquiry to the computing facility. The computing facility would retrieve user A's affinity list and would send to the location service a set of inquiries for the location of the users on that affinity list. On receiving this information, the computing facility would then calculate matches as before. This alternative would be the preferred system design in those cases where individuals wished tight control of the affinity matching process or if the cost using of the location service were sufficiently high to make the continuous monitoring of the first approach uneconomic.

One modification of the systems described above is to make the match a function of both the distance and the quality of the affinity match. Users would be alerted to closer or better affinity matches at greater minimum distances than they would be alerted for weaker affinity matches. For example, if the range of acceptable affinity matches ranged from 70 to 100, the system might alert a user if the separation between users (in meters) was less than three times the affinity score less 200. Thus, a match with a minimally acceptable affinity score, 70, would be reported only if the separation distance were 10 meters or less. In contrast, a match with a maximum score, 100, would be reported for separation distances up to 100 meters.

Figure XYZ is a flow chart illustrating the use of the system at an auto parts swap meet. (It is common for auto enthusiasts to congregate to buy and sell new and used parts. Similar groupings occur with many other special interest groups-amateur radio operators, antique collectors, sporting goods, etcetera.)

The first step is for the user to register with the computing facility that he is attending the swap meet. Such registration could be done using the wireless terminal or could be accomplished as part of the process of entering the swap meet.

The second step is for the user to enter into the wireless terminal information describing the items of interest (either to buy or sell). Such information could include descriptive text, images, moving images, or sound recordings.

After reviewing that the data have been correctly entered, the user indicates compeletion of data entry to the wireless terminal. The wireless terminal then transmits that data to the computing facility.

The computing facility continuously monitors the user's location and transmits indications of matches to the user as the user moves around the swap meet.

It is not necessary that the matching calculations be performed in the computing facility. In some circumstances it may be more efficient or convenient to perform these calculations in the wireless terminal. Figure xyz2 is a flow chart illustrating an embodiment of the system in which the matching calculations are performed in the wireless terminal. Note that performing the matching calculations in the wireless terminal might provide significant efficiency gains if (1) the terminal is mobile but the items of interest are fixed such as would occur if the wireless terminal were associated with a buyer wandering around the tables at a swap meet, or (2) if repeated communications to the wireless terminal were expensive, or (3) if the location information were naturally developed first at the wireless terminal and the performance of such matching calculation reduced the need for transmitting location information from the wireless terminal.

The first step is for the user to register—that is to indicate to the system that he (denoted Adam in the flow chart) is a participant in the swap meet.

The second step is for the user to enter or select from prestored information his personal data.

The third step is for the user to input or select information describing those items that he is interested in buying or selling. For example, a user might indicate “Chevy Truck Parts” or “Intake manifold for GMC 350 engine”

In the fourth step, the user reviews the data that he has input or selected, and after verifying its correctness, indicates that the data are correct.

The wireless terminal transmits the data to the computing facility.

The computing facility transmits information regarding that data to all registered users who are participating in the swap meet.

Each registered users wireless terminal constantly monitors or otherwise remains aware of its own location.

Each wireless terminal constantly recalculates affinity matches taking into account the changing location of the wireless terminal.

Whenever a user moves to a location sufficiently close to an item of interest, the wireless terminal signals that match to the user.

One modification of this approach is for the items for sale to be at fixed locations and the wireless terminals to be used by potential buyers.

A second modification of this approach is for the wireless terminals to be supplied with the information (type, physical location) regarding all items for sale in advance, thus not requiring use of the wireless connection to transmit such information. Indeed, in this configuration, the wireless terminal would need only the necessary computing capabilities, a source of location information, and the necessary display for communication with the user.

Another feature of this system are the security and privacy options it provides. Security and privacy technique 1: positive assent. The system operates as describe above except, before information regarding an affinity match is sent to a user, say user A, the matching user, user B, is sent an inquiry asking if the user B wishes to be affinity matched at this time? Only if the user B gives positive assent does the computing facility send the notification to user A. Alternatively, the message to user B may include summary information regarding user A—allowing user B to make a more informed decision.

Security and privacy technique 2: exclusion lists or lists of prohibited matches. The system operates as described above with security technique 1. User B has an additional capability. User B can indicate to the system, either at the time of the initial inquiry or at a later time, that user B does not wish to be matched with user A. User B would be placed on User A's exclusion list.

Security and privacy technique 3: defining conditions for participation. A user may be given the ability to define conditions under which they will or will not be included in the matching service. Such conditions could be particular days, times, dates, geographic locations or others. A user could select one or multiple conditions under which they would or would not be included.

Security and privacy technique 4: tracking matches. In addition to the aforementioned capabilities, the computer facility keeps an audit trail of all match notifications. Thus, it is possible for users or concerned third parties to retrieve information regarding matches and related communications. The system can also be programmed to record the locations of user A and user B for a period of time following a match request. The system could be arranged such that the user in not included in the matching at all under certain conditions or set such that the user is included in the matching but no alert message is sent to the user. In the latter case, the system may be arranged such that any matches for which an alert message is not sent can be stored and could be accessed at a later time. Different lists of conditions could possibly be set for different other users. For example, User A may wish to have User B alerted of a match with User A only on weekends but wishes to have User C alerted of a match with User A only on weekdays.

Security and privacy technique 5: the system operator, prior to accepting a potential user as a client, performs a background check, verifying that the user is trustworthy. For example, the system operator might only accept as users people who had post-paid cellular or PCS service and had had that service at the same address for one year or longer.

Security and privacy technique 6: multiple security or privacy levels. The system could, for example, include two levels of security. The first level could be set by User A to be a first set of conditions under which an alert message about a match with User A could be sent to User B without first obtaining consent of User B. These conditions could be days, dates, times, geographic locations, or identification of specific other users. The second level of security, which could be all conditions other than those satisfying the first level, would be the conditions under which no alert message about a match with User A could be sent to User B without first obtaining consent of User A. This second level could be sent to apply generally to all other users or could be set specific to User B. Those of skill in the art should understand that more than two levels of security could be used.

Security and privacy technique 7: verification of the identity of a user. The system additionally may include one or more methods of verifying the identity of a user. For example, consider a system that utilizes mobile phones having capabilities for taking and transmitting digital photos. When a user initially signs up for a service, the user could transmit a photo of his or her self via his or her mobile telephone. The system stores that digital photo in a database. When such a user is the subject of an affinity match, the system may require the user to again transmit a photo of his or herself, which the system can compare to its database to confirm that the same person who signed up for the service is now in possession of that particular cell phone.

Another example of security and privacy technique 7 would be to have the user take a digital photo of the user's driver's license or passport. Such a digital photo could be taken and transmitted in advance of an affinity match and stored in the system, or it could be taken and transmitted at the time of an affinity match. In either case, at the time of an affinity match, the user could be reqluired to take and transmit a digital photo of his or herself that could then be compared to the photo on the user's driver's license or passport. This would confirm with some degree of certainty the identity of the user. database could include complete information regarding matches and/or communications or could contain only summary information.

While the foregoing invention has been described in terms of its preferred embodiments, it should be understood that various modifications may be made thereto without departing from the spirit and scope of the invention as defined in the appended claims. It is intended that all such modifications fall within the scope of the appended claims.

1. A system for matching users by affinity and geographic location comprising:
a portable communications terminal associated with a first user;
a computing facility connected by a telecommunications link to said portable communications terminal;
a location service capable of providing location information regarding said portable communications terminal to said central computing facility,
means for storing information regarding affinity preferences of said first user,
means for determining a match based upon a degree of affinity correlation between said first user and second user, wherein a minimum degree of affinity correlation constituting a match varies depending on the proximity of said first and second users; and
means for generating an alert message when a match is determined by said means for determining;
means for sending said alert message to said portable communications terminal.

2. The system of claim 1 wherein said means for storing stores information regarding affinity preferences of a plurality of users.

3. The system of claim 1 wherein said means for storing is located in said computing facility.

4. The system of claim 1 wherein said portable terminal comprises a wireless telephone.

5. The system of claim 1 wherein said portable terminal comprises a portable data terminal.

6. The system of claim 1 further comprising means for establishing a communications path between said portable communications terminal associated with said first user and a portable communications terminal associated with said second user.

7. The system of claim 1 further comprising:
means for storing information regarding security and privacy preferences of said first user; and
means for enforcing said security and privacy preferences of said first user.

8. The system of claim 7 wherein said means for enforcing comprises means for said first user to input assent to an exchange of information.

9. The system of claim 7 wherein said security and privacy preferences comprise a list of prohibited matches.

10. The system of claim 7 wherein said security and privacy preferences comprise a list of conditions excluding a particular user from consideration by said means for determining.

11. The system of claim 10 wherein said conditions comprise at least one selected from the group of dates, days, times, and geographic locations.

12. The system of claim 10 wherein said conditions comprise at least two selected from the group of dates, days, times, and geographic locations.

13. The system of claim 7 wherein said security and privacy preferences comprise a list of conditions prohibiting said means for sending from sending an alert message to said portable communications terminal.

14. The system of claim 13 wherein said list of conditions comprises at least one selected from the group of dates, days, times, and geographic locations.

15. The system of claim 13 wherein said list of conditions comprises at least two selected from the group of dates, days, times, and geographic locations.

16. The system of claim 13 further comprising means for storing alert messages generated by said means for generating but not sent by said means for sending.

17. The system of claim 7 wherein said security and privacy preferences comprise first and second levels of security.

18. The system of claim 17 wherein said first level of security comprises conditions under which an alert message regarding a match between a first user and a second user may be sent to said second user without consent of said first user.

19. The system of claim 18 wherein said second level of security comprises conditions under which an alert message regarding a match between a first user and a second user may not be sent to said second user without consent of said first user.

20. The system of claim 18 in which the first level of notification message is a message indicating that an affinity match is nearby and providing limited information regarding the matching user.

21. The system of claim 19 in which the second level of notification message is a message providing sufficient information to permit the second user receiving the message to identify the first user.

22. The system of claim 1 wherein said location service maintains in a database a record of all affinity matches and associated communications.

23. The system of claim 22 wherein said database contains only summary information regarding each message.

24. The system of claim 22 wherein said database contains only complete copies of each message.

25. The system of claim 1 further comprising means for verifying the identity of a user.

26. The system of claim 25 wherein said means for verifying comprises means for checking that the user has subscribed to wireless service at a single, unchanging geographic address for a period of one year or longer.

27. The system of claim 25 wherein said means for verifying comprises examination of a governmentally-issued identification document.

28. The system of 27 wherein said governmentally-issued identification document is a driver's license.

29. The system of 27 wherein said governmentally-issued identification document is a passport.

30. The system of claim 25 wherein said means for verifying comprises biometric identification means.

31. A method for matching users by affinity and geographic location comprising the steps of:
entering into a memory at least one affinity preference of a first user having a portable communications terminal;
entering into a memory at least one affinity preference of a second user;
determining a location of said first user;
determining a location of said second user;
determining a match based upon a degree of affinity correlation between said first user and second user, wherein a minimum degree of affinity correlation constituting a match varies depending on the proximity of said first and second users;
generating an alert message when a match is determined by said determining a match step; and
sending said alert message to a portable communications terminal of at least one of said first and second users.

32. The method of claim 30 further comprising the step of determining an identity of at least one of said first and second users.
